(19) United States
(12) Patent Application Publication
(10) Pub. No.: US 2024/0134015 A1
(43) Pub. Date: Apr. 25, 2024

(54) DISTANCE MEASURING DEVICE, CONTROL METHOD THEREOF, AND DISTANCE MEASURING SYSTEM

(71) Applicant: SONY GROUP CORPORATION, TOKYO (JP)

(72) Inventors: KENICHIRO NAKAMURA, TOKYO (JP); YUSUKE MORIUCHI, TOKYO (JP); TAKAYUKI SASAKI, TOKYO (JP); MOTONOBU FUJIOKA, TOKYO (JP)

(21) Appl. No.: 18/547,027

(22) PCT Filed: Jan. 13, 2022
(86) PCT No.: PCT/JP2022/000818

§ 371 Date: Aug. 18, 2023

(30) Foreign Application Priority Data
Feb. 26, 2021 (JP) 2021-030423

(51) Int. Cl. G01S 7/4863; G01S 17/894

(52) U.S. Cl. CPC G01S 7/4863; G01S 17/894

(57) ABSTRACT

The present technology relates to a distance measuring device, a control method thereof, and a distance measuring system capable of arranging sample points of a pixel array so as to obtain more distance information. A distance measuring device includes: a pixel array in which pixels that receive reflected light obtained by reflecting irradiation light from an object are arranged in a matrix; a determination unit that determines some of the pixels of the pixel array as a sample point for detecting distance information; and a storage unit that stores a sample point state table that stores distance information of the sample point and a sample point movement rule table that stores a movement rule of the sample point, in which the determination unit updates position information of the sample point on the basis of the sample point state table and the sample point movement rule table. The present technology can be applied to, for example, a distance measuring system or the like that detects a distance from a subject in a depth direction.

### TECHNICAL FIELD

The present technology relates to a distance measuring device, a control method thereof, and a distance measuring system, and more particularly to a distance measuring device, a control method thereof, and a distance measuring system capable of arranging sample points of a pixel array so as to obtain more distance information.

### BACKGROUND ART

In recent years, a distance measuring device (hereinafter, also referred to as a depth camera) that measures a distance by a time-of-flight (ToF) method has attracted attention. There is a distance measuring device that adopts a direct ToF method among the ToF methods. In the direct ToF method, photodetectors called single photon avalanche diodes (SPADs) are arranged in light receiving pixels, respectively, and a time of flight from a timing at which irradiation light is emitted to a timing at which reflected light is received is directly measured to calculate a distance from an object. In distance measurement by the direct ToF method, in order to reduce noise caused by ambient light or the like, emission of irradiation light and reception of reflected light thereof are repeated a predetermined number of times (e.g. several times to several hundred times) to generate a histogram of time of flight of the irradiation light, and the distance from the object is calculated on the basis of the time of flight corresponding to a peak of the histogram.

A circuit scale of a time measurement unit that measures the time of flight, a histogram generation unit that generates the histogram, and a peak detection unit that detects the peak of the histogram is comparatively large. Thus, it is generally difficult to provide the above units for all the pixels. Therefore, the number of histograms that can be generated is smaller than the total number of pixels of the pixel array.

In view of this, only some pixels of the pixel array are caused to perform a light receiving operation as sample points, or a plurality of adjacent pixels is regarded as one large pixel (referred to as a multi-pixel) to generate a histogram as a sample point. In this case, the number of sample points for generating a histogram is smaller than the total number of pixels of the pixel array.

In a case where distance information is generated with the number of sample points smaller than the total number of pixels of the pixel array, how to arrange the sample points in the pixel array is important to obtain more distance information.

For example, Patent Document 1 discloses a method of increasing the density of sample points as a distance from an object is shorter and decreasing the density of sample points as ambient light noise is larger.

Note that Patent Document 2 discloses a technique of irradiating a specific region of a pixel array of a distance measuring device with irradiation light.

### CITATION LIST

### Patent Document

Patent Document 1: Japanese Patent Application Laid-Open No. 2020-112443

Patent Document 2: Japanese Patent Application Laid-Open No. 2020-076619

### SUMMARY OF THE INVENTION

### Problems to be Solved by the Invention

The technique disclosed in Patent Document 1 changes the sample points in units of rows of the pixel array and selects one sampling pattern from several kinds of sampling patterns prepared in advance. Therefore, arrangement of the sample points is restricted and can be further improved.

The present technology has been made in view of such a situation and can arrange sample points of a pixel array so as to obtain more distance information.

### Solutions to Problems

A distance measuring device according to a first aspect of the present technology includes: a pixel array in which pixels that receive reflected light obtained by reflecting irradiation light from an object are arranged in a matrix; a determination unit that determines some of the pixels of the pixel array as a sample point for detecting distance information; and a storage unit that stores a sample point state table that stores distance information of the sample point and a sample point movement rule table that stores a movement rule of the sample point, in which the determination unit updates position information of the sample point on the basis of the sample point state table and the sample point movement rule table.

In a method of controlling a distance measuring device according to a second aspect of the present technology, the distance measuring device including a pixel array in which pixels that receive reflected light obtained by reflecting irradiation light from an object are arranged in a matrix determines some of the pixels of the pixel array as a sample point for detecting distance information, stores distance information of the sample point in a sample point state table, and updates position information of the sample point on the basis of the sample point state table and a sample point movement rule table that stores a movement rule of the sample point.

A distance measuring system according to a third aspect of the present technology includes: a lighting device that emits irradiation light; and a distance measuring device that receives reflected light obtained by reflecting the irradiation light from an object, in which: the distance measuring device includes a pixel array in which pixels that receive the reflected light are arranged in a matrix, a determination unit that determines some of the pixels of the pixel array as a sample point for detecting distance information, and a storage unit that stores a sample point state table that stores distance information of the sample point and a sample point movement rule table that stores a movement rule of the sample point; and the determination unit updates position information of the sample point on the basis of the sample point state table and the sample point movement rule table.

In any one of the first to third aspects of the present technology, some of pixels of a pixel array in which pixels that receive reflected light obtained by reflecting irradiation light from an object are arranged in a matrix are determined as a sample point for detecting distance information, distance information of the sample point is stored in a sample point state table, and position information of the sample point is updated on the basis of the sample point state table and a sample point movement rule table that stores a movement rule of the sample point.

A distance measuring device and a distance measuring system may be independent devices or modules incorporated in another device.

### BRIEF DESCRIPTION OF DRAWINGS

FIG. 1 is a block diagram illustrating a configuration example of an embodiment of a distance measuring system according to the present disclosure.

FIG. 2 is a block diagram illustrating a detailed configuration example of a distance measuring system.

FIG. 3 illustrates a sample point state table.

FIG. 4 illustrates a sample point movement rule table.

FIG. 5 illustrates a first example of sample point position information update processing.

FIG. 6 illustrates the first example of the sample point position information update processing.

FIG. 7 illustrates the first example of the sample point position information update processing.

FIG. 8 illustrates a second example of the sample point position information update processing.

FIG. 9 illustrates the second example of the sample point position information update processing.

FIG. 10 is a flowchart showing distance image generation processing by a distance measuring system.

FIG. 11 illustrates another example of the movement rule table.

FIG. 12 illustrates an example of calculating a confidence of a distance.

FIG. 13 illustrates an example of calculating a confidence of a distance.

FIG. 14 is a block diagram illustrating a configuration example of another embodiment of the distance measuring system according to the present disclosure.

FIG. 15 is a block diagram illustrating a detailed configuration of a distance measuring device in a luminance observation mode.

### MODE FOR CARRYING OUT THE INVENTION

Hereinafter, modes for carrying out the present technology (hereinafter, referred to as embodiments) will be described with reference to the accompanying drawings. Note that, in the present specification and the drawings, components having substantially the same functional configuration will be denoted by the same reference signs, and redundant description will be omitted. Description will be made in the following order.

1. Configuration Example of Distance Measuring System

2. Detailed Configuration Example of Distance Measuring Device

3. First Example of Sample Point Update Processing

4. Second Example of Sample Point Update Processing

5. Flowchart of Distance Image Generation Processing

6. Another Example of Movement Rule

7. Example of Calculating Confidence of Distance

8. Another Configuration Example of Distance Measuring System

9. Configuration Example of Luminance Observation Mode

10. Conclusion

### 1. Configuration Example of Distance Measuring System

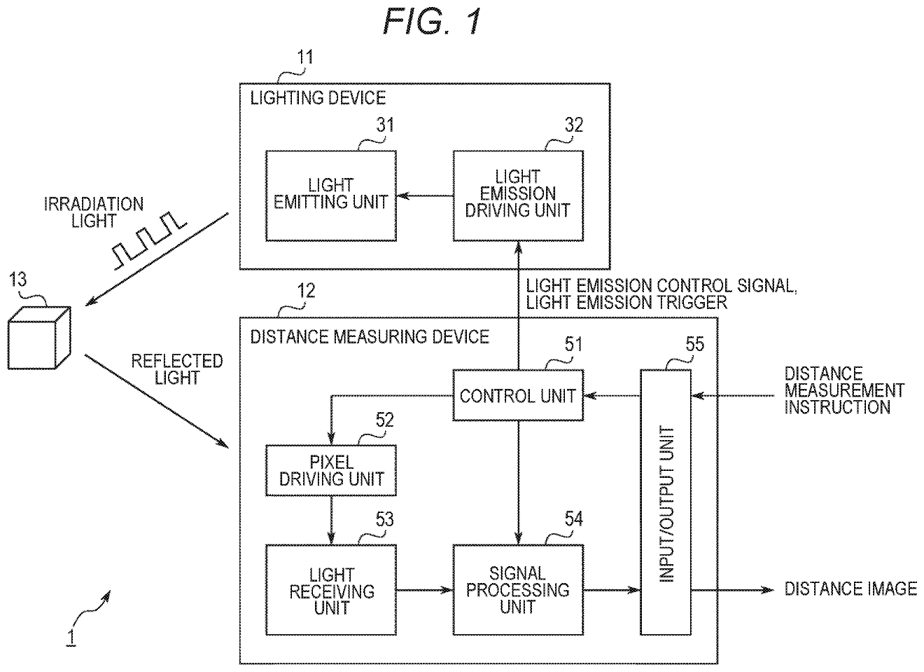

FIG. 1 is a block diagram illustrating a configuration example of an embodiment of a distance measuring system according to the present disclosure.

A distance measuring system 1 in FIG. 1 is a system that measures a distance from an object by using, for example, the time-of-flight (ToF) method and outputs the distance. Here, the distance measuring system 1 measures the distance by the direct ToF method among the ToF methods. The direct ToF method is a method of calculating a distance from an object by directly measuring a time of flight from a timing at which irradiation light is emitted to a timing at which reflected light is received.

The distance measuring system 1 can be used together with an RGB camera (not illustrated) that images a subject including an object 13 and the like. In a case where the distance measuring system 1 is used together with the RGB camera serving as an external device, the distance measuring system 1 sets the same range as an imaging range of the RGB camera as a distance measurement range and generates a distance image as distance information of the subject captured by the RGB camera.

The distance measuring system 1 includes a lighting device 11 and a distance measuring device 12 and measures a distance from a predetermined object 13 serving as the subject. More specifically, when a distance measurement instruction is supplied from an upper host device, the distance measuring system 1 repeats emission of irradiation light and reception of reflected light thereof a predetermined number of times (e.g. several times to several hundred times). The distance measuring system 1 generates a histogram of time of flight of the irradiation light on the basis of the emission of the irradiation light and the reception of the reflected light repeatedly performed a predetermined number of times and calculates the distance from the object 13 on the basis of the time of flight corresponding to a peak of the histogram.

The lighting device 11 irradiates the predetermined object 13 with irradiation light on the basis of a light emission control signal and a light emission trigger supplied from the distance measuring device 12. The irradiation light is, for example, infrared light (IR light) having a wavelength within a range of approximately 850 nm to 940 nm. The lighting device 11 includes at least a light emitting unit 31 and a light emission driving unit 32. The lighting device 11 may include a projection lens and a diffractive optical element (both not illustrated).

The light emitting unit 31 includes, for example, a vertical cavity surface emitting laser (VCSEL) array in which a plurality of VCSELs serving as a light source is arrayed in a planar manner, and each VCSEL emits/does not emit light under the control of the light emission driving unit 32. A light unit of the VCSEL (size of the light source) and a position of the VCSEL to emit light (light emitting position) can be changed under the control of the light emission driving unit 32.

The light emission driving unit 32 includes, for example, a microprocessor, an LSI, a laser driving driver, and the like and controls the light unit of the VCSEL (size of the light source) and the position of the VCSEL to emit light (light emitting position) on the basis of a light emission control signal supplied from a control unit 51 of the distance measuring device 12. Further, the light emission driving unit 32 controls a light emission timing of the VCSEL to emit light in accordance with a light emission trigger supplied from the control unit 51 of the distance measuring device 12. The light emission trigger is, for example, a pulse waveform having two values of “High(1)” and “Low(0)”, and “High” represents a timing of emitting the irradiation light.

When the distance measurement instruction is supplied, the distance measuring device 12 determines a light emission condition, for example, the size of the light source or the light emitting position. Then, the distance measuring device 12 generates a light emission control signal and a light emission trigger on the basis of the determined light emission condition, outputs the light emission control signal and the light emission trigger to the lighting device 11, and causes the lighting device 11 to emit irradiation light. Further, the distance measuring device 12 calculates the distance from the object 13 by receiving reflected light of the irradiation light reflected by the object 13 and outputs a result thereof to the upper host device as a distance image. The distance measuring device 12 includes the control unit 51, a pixel driving unit 52, a light receiving unit 53, a signal processing unit 54, and an input/output unit 55.

The control unit 51 of the distance measuring device 12 includes, for example, a field programmable gate array (FPGA), a digital signal processor (DSP), a microprocessor, and the like. When acquiring the distance measurement instruction from the upper host device via the input/output unit 55, the control unit 51 determines a light emission condition and supplies a light emission control signal and a light emission trigger corresponding to the determined light emission condition to the light emission driving unit 32 of the lighting device 11. The light emission trigger is also supplied to the signal processing unit 54 as a timing notification of the start of counting the time of flight.

Further, the control unit 51 determines which pixel of the light receiving unit 53 is set as an active pixel in accordance with the determined light emission condition and supplies sample point control information for specifying the active pixel to the pixel driving unit 52. The active pixel is a pixel that detects incidence of photons. A pixel that does not detect incidence of photons is referred to as an inactive pixel.

The light receiving unit 53 includes a pixel array in which pixels are two-dimensionally arranged in a matrix. Each pixel of the light receiving unit 53 includes a single photon avalanche diode (SPAD) as a photoelectric conversion element. The SPAD instantaneously detects one photon by multiplying a carrier generated by photoelectric conversion in a high electric field PN junction region (multiplication region). When detecting the incidence of the photon, each active pixel of the light receiving unit 53 outputs a detection signal indicating that the photon has been detected to the signal processing unit 54.

The signal processing unit 54 generates a histogram of time (count value) from emission of irradiation light to reception of reflected light thereof on the basis of the emission of the irradiation light and the reception of the reflected light repeatedly performed a predetermined number of times (e.g. several times to several hundred times). A unit for generating a histogram (histogram generation unit) may be one pixel unit or may be a multi-pixel unit in which a plurality of adjacent pixels is regarded as one large pixel (referred to as a multi-pixel). Then, the signal processing unit 54 detects the peak of the generated histogram to determine time until light emitted from the lighting device 11 is reflected and returns from the object 13, obtains the distance from the object 13 on the basis of the determined time and speed of light, and generates a distance image. The generated distance image is output to the upper host device via the input/output unit 55. The signal processing unit 54 includes, for example, a field programmable gate array (FPGA), a digital signal processor (DSP), a logic circuit, and the like.

The input/output unit 55 supplies the distance measurement instruction supplied from the upper host device to the control unit 51. Further, the input/output unit 55 outputs the distance image supplied from the signal processing unit 54 to the upper host device. The input/output unit 55 can include, for example, a communication interface or the like conforming to the Mobile Industry Processor Interface (MIPI).

The distance measuring device 12 configured as described above has two modes, i.e., a distance measurement mode and a luminance observation mode as operation modes. The distance measurement mode is a mode in which some of a plurality of pixels included in the light receiving unit 53 are set as active pixels, the remaining pixels are set as inactive pixels, and a distance image is generated and output on the basis of distances detected by the active pixels. Meanwhile, the luminance observation mode is a mode in which all the pixels of the light receiving unit 53 are set as active pixels, and a luminance image in which the number of photons input for a certain period is counted as a luminance value (pixel value) is generated.

In the distance measurement mode, the distance measuring device 12 sets a plurality of sample points in the pixel array of the light receiving unit 53, generates a histogram for each sample point, obtains the distance from the object 13 by detecting the peak of the histogram, and generates a distance image. The sample point may include one pixel or may include a multi-pixel. However, the number of sample points set in the pixel array is smaller than the total number of pixels of the pixel array. In a case where all the pixels of the pixel array are not used and only some of the pixels are used as described above, how to arrange the sample points in the pixel array is important to obtain more distance information of the object 13. The distance measuring device 12 generates a distance image by controlling the number of sample points smaller than the total number of pixels of the pixel array so as to optimally arrange the sample points.

### 2. Detailed Configuration Example of Distance Measuring Device

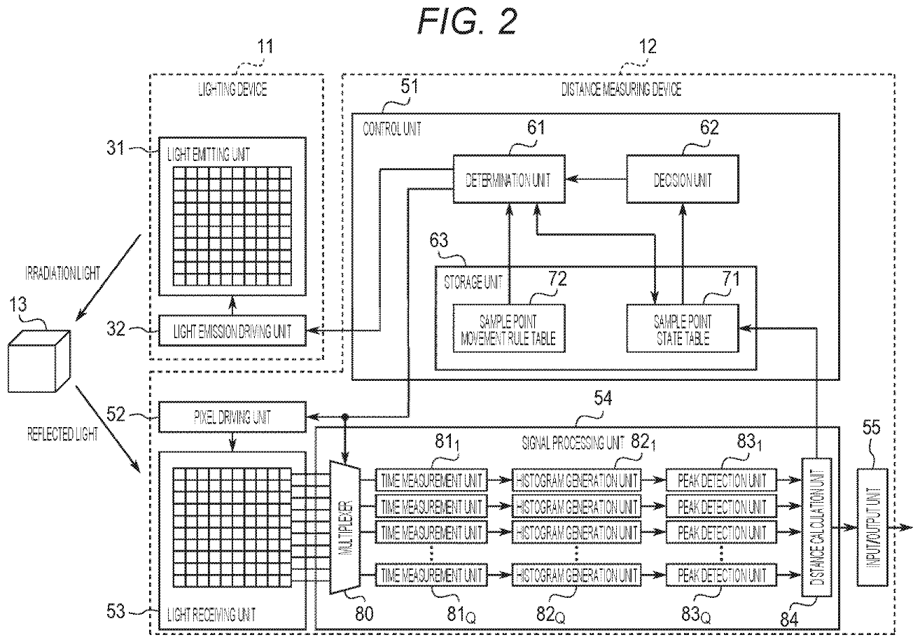

FIG. 2 is a block diagram of the distance measuring system 1 having a more detailed configuration example of the distance measuring device 12 in a case where the operation mode is the distance measurement mode.

The distance measuring device 12 includes the control unit 51, the pixel driving unit 52, the light receiving unit 53, the signal processing unit 54, and the input/output unit 55. Note that FIG. 2 omits a control signal supplied from the input/output unit 55 to the control unit 51 in a case where a distance measurement instruction is input to the input/output unit 55.

The control unit 51 includes a determination unit 61, a decision unit 62, and a storage unit 63, and the storage unit 63 stores a sample point state table 71 and a sample point movement rule table 72.

The signal processing unit 54 includes a multiplexer 80, time measurement units 81₁ to 81_{Q}, histogram generation units 82₁ to 82_{Q}, peak detection units 83₁ to 83_{Q}, and a distance calculation unit 84. That is, the signal processing unit 54 includes Q (Q>1) time measurement units 81, Q histogram generation units 82, and Q peak detection units 83 and can generate Q histograms. A value of Q corresponds to the maximum number of settable sample points and is smaller than the total number of pixels of the pixel array of the light receiving unit 53. However, the value of Q may be the same as the total number of pixels of the light receiving unit 53. In that case, in a case where operation is performed by setting the number of histograms to be generated to be smaller than the total number of pixels of the pixel array in order to reduce power consumption or increase processing speed, it is possible to perform optimal arrangement control of sample points described later.

When a distance measurement instruction is supplied from the upper host device via the input/output unit 55, the determination unit 61 determines a light emission condition of the light emitting unit 31 of the lighting device 11. That is, the determination unit 61 determines the light unit of the VCSEL (size of the light source) and the position of the VCSEL to emit light and supplies a light emission control signal indicating which VCSEL of the VCSEL array is caused to emit light to the light emission driving unit 32 of the lighting device 11. In the present embodiment, all the VCSELs of the VCSEL array are caused to emit light with uniform luminance in order to simplify the description. However, as described later, the light emitting positions can be limited to a part of the VCSEL array depending on arrangement of sample positions or the like. After transmitting the light emission control signal or by supplying a light emission trigger together with the light emission control signal to the light emission driving unit 32, the determination unit 61 causes the light emitting unit 31 to start emitting light.

Further, the determination unit 61 determines initial positions of the sample points with respect to the pixel array of the light receiving unit 53, generates the sample point state table 71 corresponding to the initial positions, and stores the sample point state table 71 in the storage unit 63. The determination unit 61 supplies sample point control information for specifying the active pixels to the pixel driving unit 52 and the multiplexer 80 on the basis of the sample point state table 71. The sample point control information includes information indicating the active pixels of the pixel array of the light receiving unit 53 and information indicating a constituent unit of the multi-pixel.

When the first distance image is generated by using the sample points at the initial positions and the sample point state table 71 of the storage unit 63 is updated, the decision unit 62 notifies the determination unit 61 of the update of the sample point state table 71. When acquiring the update notification of the sample point state table 71 from the decision unit 62, the determination unit 61 updates position information of the sample points on the basis of the sample point state table 71 and the sample point movement rule table 72. Specifically, the determination unit 61 updates the position information of the sample points on the basis of current distance information of each sample point recorded in the sample point state table 71 and a movement rule recorded in the sample point movement rule table 72. As the position information of the sample points is updated, the sample point state table 71 is also updated. The determination unit 61 generates sample point control information on the basis of the updated sample point state table 71 and supplies the sample point control information to the pixel driving unit 52 and the multiplexer 80. By repeating generation of a distance image and update of the sample point state table 71 based on the generated distance image a predetermined number of times, the sample points of the pixel array are updated to optimal arrangement. Note that the sample point movement rule table 72 may include not only an individual sample point movement rule for each sample point, but also an entire rule applied to all the sample points.

The decision unit 62 determines whether or not the sample point state table 71 stored in the storage unit 63 has been updated. In a case where it is determined that the sample point state table 71 has been updated, the decision unit 62 notifies the determination unit 61 of the update of the sample point state table 71.

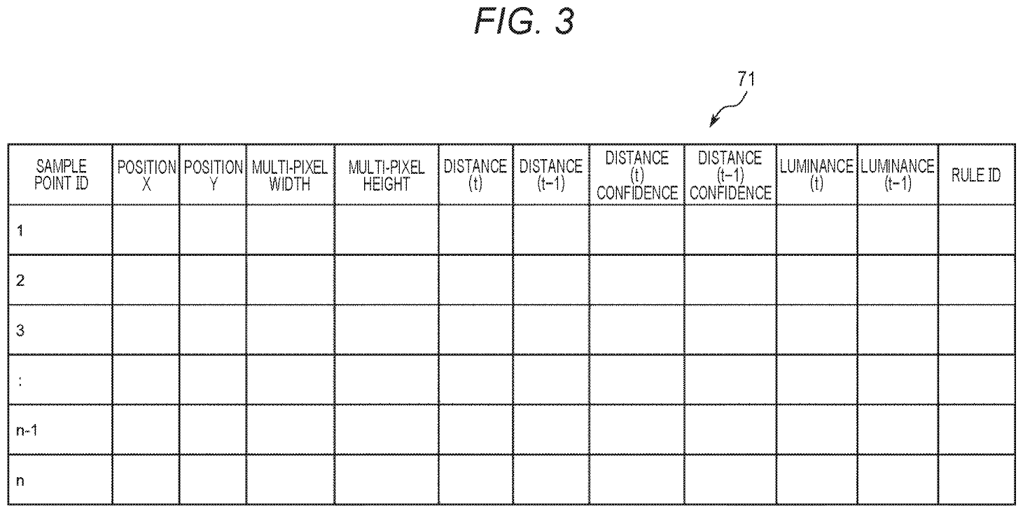

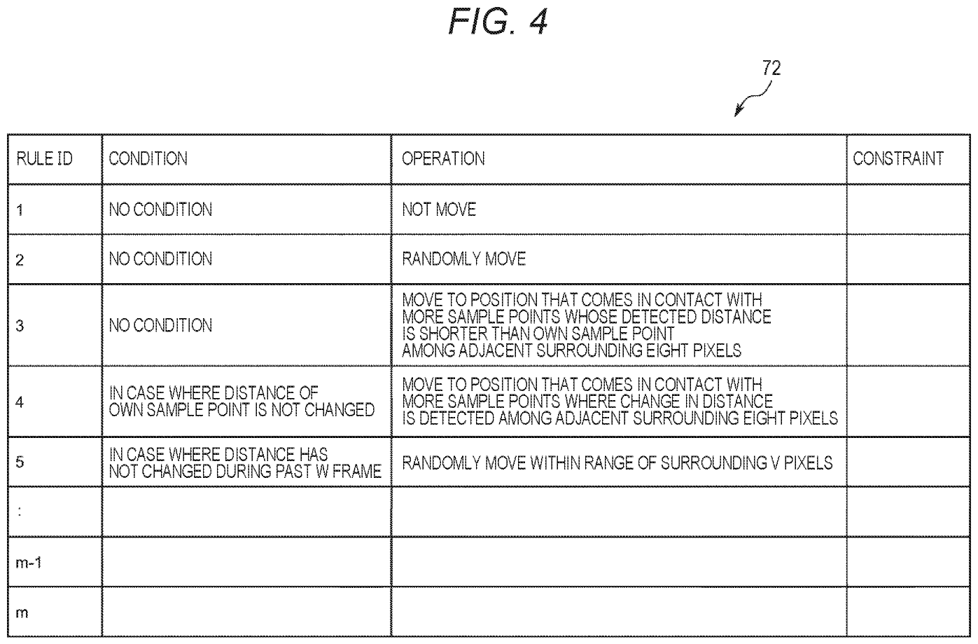

The sample point state table 71 and the sample point movement rule table 72 stored in the storage unit 63 will be described with reference to FIGS. 3 and 4.

FIG. 3 illustrates an example of the sample point state table 71.

The sample point state table 71 stores information regarding each of a plurality of sample points set in the pixel array of the light receiving unit 53. In the sample point state table 71 of FIG. 3, n (n>0) sample points are set in the pixel array.

In the sample point state table 71, a sample point ID (sample point identification information) for identifying a sample point is given to each of the n sample points set in the pixel array. Further, the sample point state table 71 stores position information, distance information, confidence information, luminance information, and a rule ID for each sample point.

The position information is information indicating a position of a multi-pixel forming the sample point. Specifically, the position information includes a pixel position (X coordinate, Y coordinate) as a representative position of the multi-pixel, a multi-pixel width that is the number of pixels of the multi-pixel in the X direction, and a multi-pixel height that is the number of pixels of the multi-pixel in the Y direction. In a case where the sample point includes one pixel, the multi-pixel width and the multi-pixel height are “1”.

The distance information is information regarding a distance calculated at the sample point. The distance information can store distance information of at least past two frames (two times) such that a change in distance can be detected. Specifically, a distance (t) calculated at the latest time t and a distance (t−1) calculated at a time (t−1) immediately therebefore can be recorded. Distance information of past several frames, i.e., three or more frames may be stored.

The confidence information is information indicating a confidence of the distance calculated at the sample point. The confidence information can also be recorded for the same number of frames as the distance information. Although a specific calculation example of the confidence will be described later, for example, the confidence can be calculated on the basis of a difference between a count value (height of the histogram) of a bin in which the peak is detected in the histogram and a count value of a bin other than the bin of the peak.

The luminance information is information indicating luminance calculated at the sample point. The luminance information can also be recorded for the same number of frames as the distance information. The luminance information can be, for example, the count value (height of the histogram) of the bin in which the peak is detected in the histogram. Alternatively, a luminance value measured by changing the operation mode to the luminance observation mode or a luminance value of an image captured by the RGB camera that is an external device may be used.

The rule ID is rule identification information indicating a rule applied to the sample point. A specific rule corresponding to the rule ID is described in the sample point movement rule table 72.

FIG. 4 illustrates an example of the sample point movement rule table 72.

In the sample point movement rule table 72, items of “condition”, “operation”, and “constraint” can be defined for each rule ID.

The “condition” indicates a condition for the sample point to perform a moving operation defined by the “operation”. In a case where the sample point does not satisfy the content described in the “condition”, the moving operation defined by the item “operation” is not performed. “No condition” indicates that the moving operation defined by the “operation” is performed without any condition.

The “operation” indicates a moving operation performed on the sample point in a case where the sample point satisfies the content described in the “condition”.

The “constraint” indicates a constraint condition in a case where the moving operation defined by the “operation” is performed. That is, the operation defined by the “operation” is performed while the condition described in “constraint” is satisfied. The “constraint” can be omitted.

The sample point movement rule table 72 of FIG. 4 defines that, for example, processing of not moving the sample point is unconditionally applied to the sample point as the rule ID=1. As the rule ID=2, it is defined that processing of randomly moving the sample point is unconditionally applied to the sample point.

As the rule ID=3, it is defined that processing of moving the sample point to a position that comes in contact with more sample points whose detected distance is shorter than the own sample point among adjacent surrounding eight pixels is unconditionally applied to the sample point.

As the rule ID=4, it is defined that processing of moving the sample point to a position that comes in contact with more sample points where a change in distance is detected among adjacent surrounding eight pixels is unconditionally applied to the sample point under a condition that a distance of the own sample point is not changed.

As the rule ID=5, it is defined that the sample point is randomly moved within a range of surrounding V pixels (V>0) under a condition that the distance has not changed during a past W frame (W>0).

Because a desired movement rule is appropriately set in the sample point movement rule table 72 as described above, various sample point update algorithms can be implemented depending on the purpose. The content of the sample point movement rule table 72 can be changed by, for example, the upper host device.

Returning to the description of FIG. 2, the determination unit 61 performs the operation of the rule ID designated in the sample point state table 71 on each sample point with reference to the sample point movement rule table 72 and updates the position information of the sample point. As the position information of the sample points is updated, the sample point state table 71 is also updated.

Note that the sample point movement rule table 72 of FIG. 4 defines the individual sample point movement rule for each sample point, but, in addition to the above rules, the determination unit 61 can define and perform the entire rule applied in common to all the sample points. In a case of performing the entire rule, the determination unit 61 performs the entire rule after applying the individual rule for each sample point based on the sample point movement rule table 72. The entire rule may be incorporated in advance as a common rule, or a plurality of entire rules may be stored in the storage unit 63 as in the sample point movement rule table 72, and the entire rule to be applied may be appropriately switched.

As an example of the entire rule, for example, the following content can be defined.

(A) After the individual rule based on the sample point movement rule table 72 is applied, in a case where there is a region where the distance information has not been measured for a predetermined period (predetermined number of frames), the sample point is speculatively arranged in the region.

(B) After the individual rule based on the sample point movement rule table 72 is applied, in a case where there is a sample point where the distance information has not been changed for a predetermined period (predetermined number of frames), the sample point is moved to the initial position. In this case, it is necessary to store the initial position for each sample point.

The pixel driving unit 52 controls the active pixels and the inactive pixels on the basis of the sample point control information supplied from the determination unit 61. In other words, the pixel driving unit 52 controls on/off of a light receiving operation of each pixel of the light receiving unit 53. When incidence of a photon is detected in each pixel set as the active pixel in the light receiving unit 53, a detection signal indicating that the photon has been detected is output to the multiplexer 80 of the signal processing unit 54 as a pixel signal.

The multiplexer 80 distributes pixel signals supplied from the active pixels of the light receiving unit 53 to any one of the time measurement units 81₁ to 81_{N} on the basis of the sample point control information supplied from the determination unit 61. More specifically, the multiplexer 80 appropriately selects a pixel signal of one or more active pixels forming sample point of the light receiving unit 53 and performs control to supply the selected pixel signal to the same time measurement unit 81ᵢ (i=any one of 1 to Q) for each sample point set in the light receiving unit 53.

Although not illustrated in FIG. 2, a light emission trigger output from the control unit 51 to the light emission driving unit 32 of the lighting device 11 is also supplied to the time measurement units 81ᵢ to 81_{Q} of the signal processing unit 54. Based on a light emission timing indicated by the light emission trigger and the pixel signal supplied from each active pixel of the sample point, the time measurement unit 81ᵢ generates a count value corresponding to a time from when the light emitting unit 31 emits irradiation light to when the active pixel receives reflected light. The generated count value is supplied to the corresponding histogram generation unit 82ᵢ. The time measurement unit 81ᵢ is also referred to as a time to digital converter (TDC).

The histogram generation unit 82ᵢ creates a histogram of the count values on the basis of the count values supplied from the time measurement unit 81ᵢ. Data of the generated histogram is supplied to the corresponding peak detection unit 83ᵢ.

The peak detection unit 83ᵢ detects the peak of the histogram on the basis of the data of the histogram supplied from the histogram generation unit 82ᵢ. The peak detection unit 83ᵢ supplies the count value corresponding to the detected peak of the histogram to the distance calculation unit 84.

The distance calculation unit 84 calculates the time of flight of the irradiation light on the basis of the count value corresponding to the peak of the histogram supplied from each of the peak detection units 83₁ to 83_{N} in units of sample points. Further, the distance calculation unit 84 calculates a distance from the subject on the basis of the calculated time of flight and generates a distance image storing the distance that is a calculation result as a pixel value. The generated distance image is output to the upper host device via the input/output unit 55 and is also supplied to the control unit 51, and the distance information and the like of the sample point state table 71 are updated.

In a case where the operation mode is the distance measurement mode, the distance measuring device 12 is configured as described above.

### 3. First Example of Sample Point Update Processing

Next, sample point position information update processing based on the sample point state table 71 and the sample point movement rule table 72, which is performed by the determination unit 61, will be described.

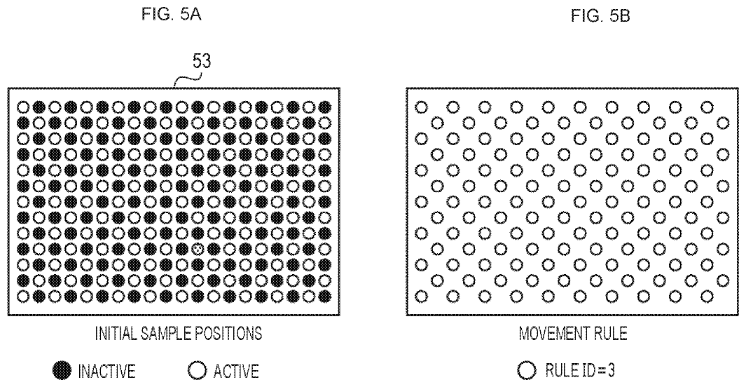

First, a first example of the sample point position information update processing will be described with reference to FIGS. 5 to 7.

The first example is an example where the rule ID=3 of the sample point movement rule table 72 in FIG. 4 is applied to all the sample points of the pixel array and the position information of the sample points is updated.

A of FIG. 5 illustrates the initial positions of the sample points determined by the determination unit 61 with respect to the pixel array of the light receiving unit 53.

In A of FIG. 5, each sample point is set as one pixel for the sake of simplicity, and white circles (∘) represent pixels set as active pixels, that is, sample points, whereas black circles (●) represent pixels set as inactive pixels. In the example in A of FIG. 5, the sample points are dispersedly arranged in the entire pixel array as the initial positions of the sample points so as to be equally distributed.

B of FIG. 5 illustrates the movement rule applied to each sample point set in the pixel array.

White circles in B of FIG. 5 indicate that the rule ID=3, that is, the rule of unconditionally performing the processing of moving the sample point to a position that comes in contact with more sample points whose detected distance is shorter than the own sample point among adjacent surrounding eight pixels is applied to the sample points as the movement rule. Positions of the white circles in B of FIG. 5 correspond to positions of the sample points in A of FIG. 5.

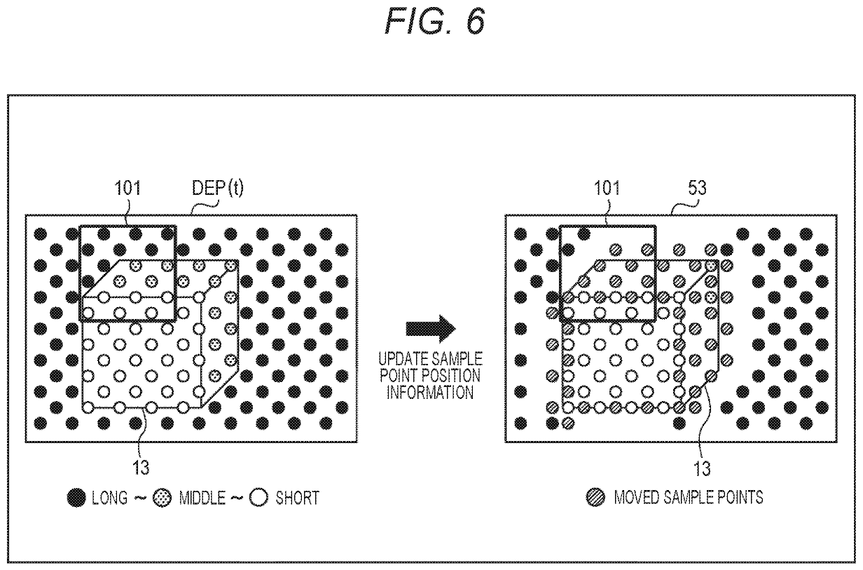

A distance image DEP(t) generated at the time t by using the initial positions of the sample points in A of FIG. 5 is illustrated on the left side of FIG. 6.

In the distance image DEP(t) of FIG. 6, distances calculated for the sample points in A of FIG. 5 are indicated by gray values.

Specifically, in the distance image DEP(t) of FIG. 6, the calculated distances are classified into three distances, i.e., the shortest first distance (hereinafter, also referred to as a short distance), a middle second distance (hereinafter, also referred to as a middle distance), and a longest third distance (hereinafter, also referred to as a long distance), and each sample point is represented by a black circle, dot pattern, or white circle corresponding to the calculated distance. The sample points represented by white are sample points where the short distance has been observed. The sample points represented by the dot pattern are sample points where the middle distance has been observed. The sample points represented by black are sample points where the long distance has been observed. Regarding a relationship with the object 13 serving as the subject, the short distance is observed at sample points corresponding to a front surface of the object 13 (surface facing the distance measuring device 12), and the middle distance is observed at sample points corresponding to the other surfaces of the object 13. Further, the long distance is observed at sample points corresponding to the background other than the object 13. The distance image DEP(t) can be grasped from the distance information stored in the sample point state table 71.

The determination unit 61 applies the rule ID=3 to each sample point by using the distance information indicated by the distance image DEP(t) and updates the position information of the sample point. The sample points of the light receiving unit 53 after the position information is updated are illustrated on the right side of FIG. 6.

In the sample points of the light receiving unit 53 on the right side of FIG. 6, hatched circles represent sample points whose positions have been moved from the initial positions, that is, from the positions of the white circles (∘) in A of FIG. 5 by the position information update processing.

When the positions of the sample points subjected to the update processing are seen, the sample points have moved to a short distance part of an imaging scene, specifically, to the region of the object 13. Thus, it is possible to obtain a distance image having a higher spatial resolution for the short distance.

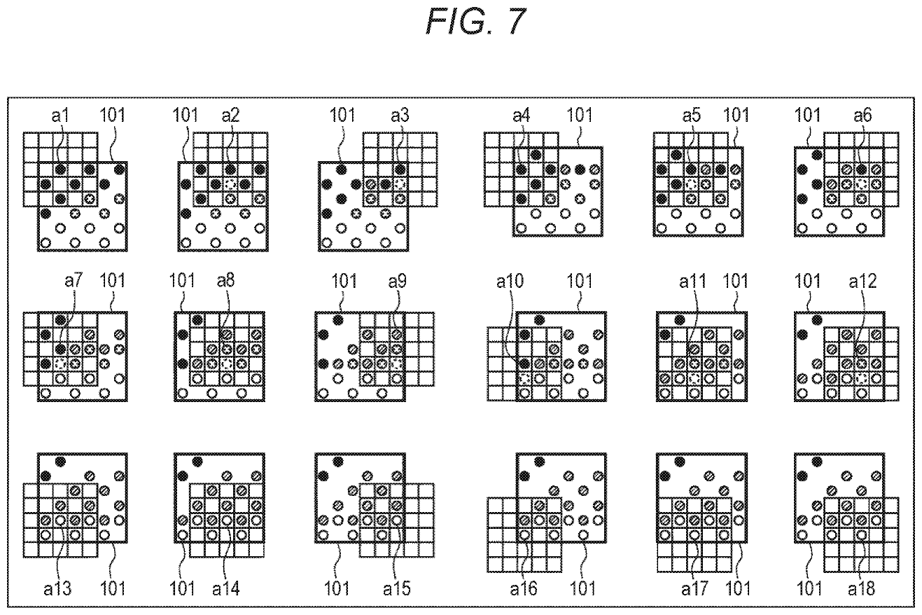

An example where the movement rule of the rule ID=3 is applied to 18 sample points included in a region 101 among a large number of sample points in the distance image DEP(t) of FIG. 6 and the position information is updated will be described with reference to FIG. 7.

Regarding the 18 sample points included in the region 101, for convenience sake, the uppermost left sample point is represented by a1, the sample point to immediate right of the sample point is represented by a2, and the sample points are represented by a2, a3, . . . , and a18 in a raster-scan direction.

First, the determination unit 61 determines whether to move a sample position of the sample point a1 on the basis of the movement rule of the rule ID=3. Specifically, the determination unit 61 focuses on the distance information of 5×5 positions around the sample point a1 and determines whether or not the sample point a1 can be brought into contact with more short distance points than the current sample position in a case where the sample point a1 is moved to any one of surrounding eight pixels. Among the surrounding eight pixels, the sample point cannot move to the current position of the sample point or positions outside the pixel array region, and thus determination thereof can be omitted. Regarding the sample point a1, there is no position that can be brought into contact with more short distance points than the current sample position, and thus the determination unit 61 does not move the sample position.

Next, the determination unit 61 determines whether to move a sample position of the sample point a2 on the basis of the movement rule of the rule ID=3. Specifically, the determination unit 61 focuses on the distance information of 5×5 positions around the sample point a2 and determines whether or not the sample point a2 can be brought into contact with more short distance points than the current sample position in a case where the sample point a2 is moved to any one of surrounding eight pixels. When the sample point a2 is moved in a downward direction of the current sample position, the sample point a2 can be brought into contact with a middle distance sample point indicated by the dot pattern. Therefore, the determination unit 61 moves the sample position to a position in the downward direction indicated by a broken line.

Next, the determination unit 61 determines whether to move a sample position of the sample point a3 on the basis of the movement rule of the rule ID=3. Specifically, the determination unit 61 focuses on the distance information of 5×5 positions around the sample point a3 and determines whether or not the sample point a3 can be brought into contact with more short distance points than the current sample position in a case where the sample point a3 is moved to any one of surrounding eight pixels. When the sample point a3 is moved in a downward direction of the current sample position, the sample point a3 can be brought into contact with a middle distance sample point indicated by the dot pattern. Therefore, the determination unit 61 moves the sample position to a position in the downward direction indicated by a broken line.

Next, the determination unit 61 determines whether to move a sample position of the sample point a4 on the basis of the movement rule of the rule ID=3. Specifically, the determination unit 61 focuses on the distance information of 5×5 positions around the sample point a4 and determines whether or not the sample point a4 can be brought into contact with more short distance points than the current sample position in a case where the sample point a4 is moved to any one of surrounding eight pixels. Regarding the sample point a4, there is no position that can be brought into contact with more short distance points than the current sample position, and thus the determination unit 61 does not move the sample position.

Similarly, also for the sample points a5 to a18, it is determined whether to move each sample position on the basis of the movement rule of the rule ID=3, and the sample position is moved in a case where it is determined that the sample point can be brought into contact with more short distance points than the current sample position.

The region 101 in FIG. 7 after the sample point update processing is completed up to the sample point a18 is the same as the region 101 of the light receiving unit 53 in FIG. 6.

### 4. Second Example of Sample Point Update Processing

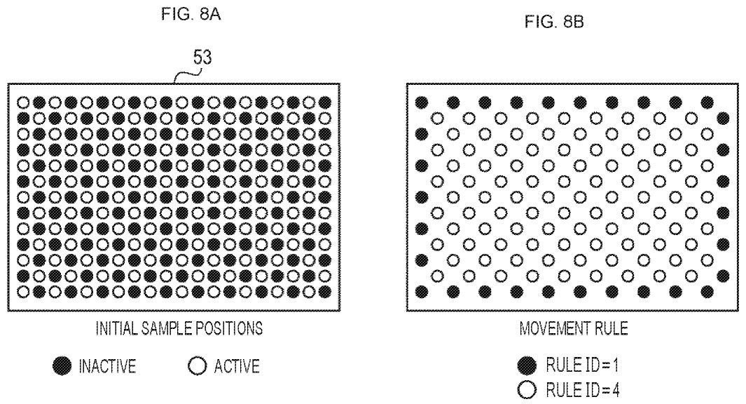

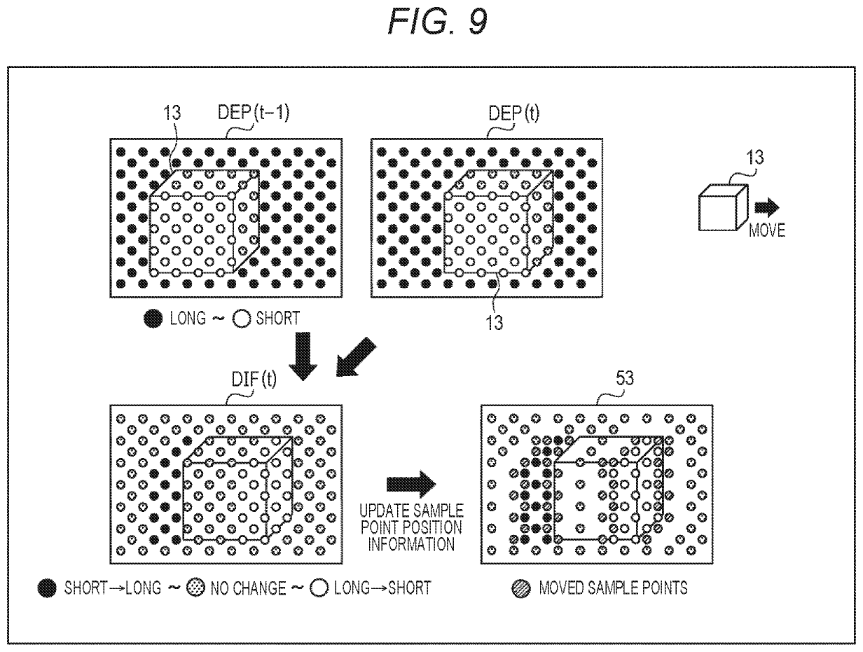

Next, a second example of the sample point position information update processing will be described with reference to FIGS. 8 and 9.

In the first example described above, one rule, that is, the rule ID=3, is applied to all the sample points of the pixel array. In the second example, there will be described an example where a plurality of rules is applied to the entire pixel array by dividing the entire pixel array into a plurality of regions and applying different rules to the respective regions.

More specifically, the determination unit 61 applies the rule ID=1 to the sample points in an outer peripheral region near the angle of view of the pixel array, applies the rule ID=4 to the sample points in an internal region inside the outer peripheral region, and updates the position information of the sample points.

A of FIG. 8 illustrates the initial positions of the sample points determined by the determination unit 61 with respect to the pixel array of the light receiving unit 53. Because the initial positions are similar to those of the first example described above, the description thereof is omitted. Note that, also in the second example, the sample point is considered as one pixel for simplicity.

B of FIG. 8 illustrates the movement rule applied to each sample point set in the pixel array.

Black circles in B of FIG. 8 represent sample points to which the movement rule of the rule ID=1 is applied. In the movement rule of the rule ID=1, the processing of not moving the position of the sample point is unconditionally performed. That is, positions of the black circle sample points do not move regardless of the detected distance. The movement rule is set for the purpose of preventing missing of detecting an object appearing from the outside of the angle of view of a distance measurement range in continuous distance measurement.

Meanwhile, white circles in B of FIG. 8 represent sample points to which the movement rule of the rule ID=4 is applied. In the movement rule of the rule ID=4, the processing of moving the sample point to a position that comes in contact with more sample points where a change in distance is detected among adjacent surrounding eight pixels is unconditionally performed.

According to the movement rule of the rule ID=4, it is necessary to know the change in distance, and thus distance images of two frames are required. Therefore, first, the determination unit 61 repeats light irradiation and light emission a predetermined number of times in the sample points at the initial positions, thereby generating distance images of two frames, i.e., a distance image DEP(t−1) at the time (t−1) and a distance image DEP(t) at the subsequent time (t).

The distance image DEP(t−1) and the distance image DEP(t) in FIG. 9 are images in which distances calculated for the sample points at the initial positions are indicated by gray values. The meanings of black, a dot pattern, and white of the sample points indicated by the distance images DEP(t−1) and DEP(t) of the two frames are similar to those of the first example. In the second example, as illustrated in the upper right of FIG. 9, the object 13 moves in a right direction indicated by the arrow during the distance measurement of the two frames. Therefore, the position of the object 13 in the distance image is different between the distance image DEP(t−1) and the distance image DEP(t). The distance image DEP(t−1) and the distance image DEP(t) can be grasped from the distance information stored in the sample point state table 71.

The determination unit 61 calculates a distance difference between the corresponding sample points of the distance images DEP(t−1) and DEP(t) and generates a distance difference image DIF(t).

In the distance difference image DIF(t) of FIG. 9, each sample point is represented by black, the dot pattern, or white. In the example, the calculated distance differences are classified into three types: a distance change in which the distance difference has changed from near to far (hereinafter, also referred to as a long distance change), no distance change, and a distance change in which the distance difference has changed from far to near (hereinafter, also referred to as a short distance change). The sample points represented by black are sample points where the long distance change has been observed. The sample points represented by the dot pattern are sample points where no distance change has been observed. The sample points represented by white are sample points where the short distance change has been observed.

As in the processing described with reference to FIG. 7, based on the distance difference image DIF(t), the determination unit 61 focuses on the distance difference of 5×5 positions around the sample point to which the rule ID=4 is applied and determines whether or not the sample point can be brought into contact with more distance change points than the current sample position in a case where the sample point is moved to any one of surrounding eight pixels. When the position information update processing is completed for all the sample points to which the rule ID=4 is applied, the updated sample points of the light receiving unit 53 are illustrated on the right side of FIG. 9.

When the positions of the sample points subjected to the update processing are seen, the sample points have moved near the object 13 moving in the imaging scene. Thus, it is possible to obtain a distance image having a higher motion tolerance ability.

In the first example and the second example of the sample point update processing described above, each sample point includes one pixel, and the determination unit 61 refers to the distance information of 5×5 pixels around the current position of the sample point and performs control to move the sample point to a pixel matching with the “operation” in the sample point movement rule table 72 among the surrounding 3×3 eight pixels. A reference range of the distance information, i.e., 5×5 pixels, and a movable range, i.e., 3×3 pixels, are merely examples, and the ranges are not limited thereto. Further, the reference range of the distance information and the movable range of the sample point can also change depending on whether the sample point includes a plurality of adjacent pixels or one pixel. The determination unit 61 applies the movement rule on the basis of distance information of a first peripheral region (reference range) around the sample point, determines whether or not to move the sample point to a predetermined position of a second peripheral region (movable range) smaller than the first peripheral region, and updates position information of the sample point.

### 5. Flowchart of Distance Image Generation Processing

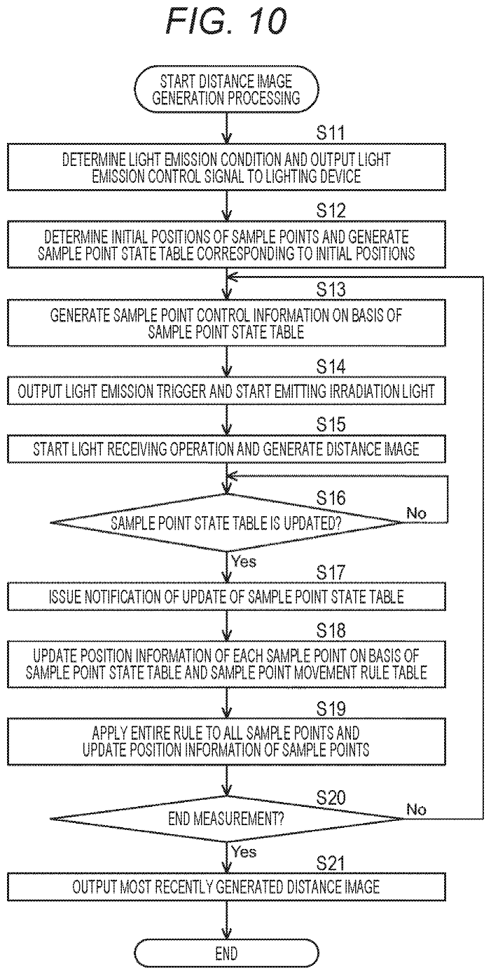

Next, an overall flow of distance image generation processing by the distance measuring system 1 will be described with reference to a flowchart of FIG. 10. The processing is started in a case where, for example, a distance measurement instruction is supplied from the upper host device.

First, in step S11, the determination unit 61 of the distance measuring device 12 determines a light emission condition and outputs a light emission control signal indicating which VCSEL of the VCSEL array is caused to emit light to the light emission driving unit 32 of the lighting device 11 on the basis of the determined light emission condition. For example, a light emission control signal that causes the entire VCSEL array to emit light with uniform luminance is output from the distance measuring device 12 to the lighting device 11.

In step S12, the determination unit 61 determines initial positions of the sample points with respect to the pixel array of the light receiving unit 53, generates the sample point state table 71 corresponding to the determined initial positions, and stores the sample point state table in the storage unit 63.

In step S13, the determination unit 61 generates sample point control information on the basis of the sample point state table 71 and supplies the sample point control information to the pixel driving unit 52 and the multiplexer 80.

In step S14, the determination unit 61 generates a light emission trigger, outputs the light emission trigger to the light emission driving unit 32 of the lighting device 11, and starts emitting irradiation light. The light emission driving unit 32 turns on and off a predetermined VCSEL of the light emitting unit 31 on the basis of the light emission trigger. The light emission trigger is also supplied to the time measurement units 81₁ to 81_{Q} of the signal processing unit 54.

In step S15, the distance measuring device 12 starts a light receiving operation and generates a distance image. More specifically, the pixel driving unit 52 drives a predetermined pixel as an active pixel on the basis of the sample point control information supplied from the determination unit 61. When a photon is detected in the active pixel, a detection signal indicating the detection is output as a pixel signal to the signal processing unit 54 via the multiplexer 80. The multiplexer 80 of the signal processing unit 54 performs control such that the pixel signal supplied from each active pixel is supplied to the predetermined time measurement unit 81ᵢ in units of sample points on the basis of the sample point control information. The time measurement unit 81ᵢ generates a count value corresponding to the time of flight of the irradiation light and supplies the count value to the corresponding histogram generation unit 82ᵢ. The histogram generation unit 82ᵢ creates a histogram of the count values on the basis of the count values supplied from the time measurement unit 81ᵢ. The peak detection unit 83ᵢ detects the peak of the histogram on the basis of data of the histogram supplied from the histogram generation unit 82ᵢ. The distance calculation unit 84 calculates the time of flight of the irradiation light on the basis of the count value corresponding to the peak of the histogram supplied from each of the peak detection units 83₁ to 83_{N} in units of sample points. The distance calculation unit 84 calculates a distance from the subject on the basis of the calculated time of flight and generates a distance image storing the distance that is a calculation result as a pixel value. The generated distance image is output to the upper host device via the input/output unit 55 and is also supplied to the control unit 51, and the distance information and the like of the sample point state table 71 are updated. The distance image may not be output to the upper host device.

In step S16, the decision unit 62 monitors the sample point state table 71 of the storage unit 63 and determines whether or not the sample point state table 71 has been updated. The decision unit 62 repeats the processing in step S16 until it is determined that the sample point state table 71 has been updated.

Then, in a case where it is determined in step S16 that the sample point state table 71 has been updated, the processing proceeds to step S17, and the decision unit 62 notifies the determination unit 61 of the update of the sample point state table 71.

In step S18, the determination unit 61 acquires the update notification of the sample point state table 71 from the decision unit 62 and updates the position information of each sample point on the basis of the sample point state table 71 and the sample point movement rule table 72. More specifically, the position information of the sample point is updated on the basis of current distance information of each sample point recorded in the sample point state table 71 and the movement rule recorded in the sample point movement rule table 72. For example, in a case where the rule ID=3 is applied to each sample point, the position information update processing as in the first example of the sample point update processing described above is performed. As the position information of the sample points is updated, the sample point state table 71 is also updated.

In step S19, the determination unit 61 applies the entire rule to all the sample points and updates the position information of the sample points. For example, in a case where there is a region where the distance information has not been sampled for a long period, the determination unit 61 performs processing of speculatively arranging sample points in the region as the entire rule.

In step S20, the determination unit 61 of the control unit 51 determines whether or not to end the distance measurement. For example, in a case where the distance image is generated and output a predetermined number of times determined in advance, the determination unit 61 determines to end the distance measurement. Further, for example, the determination unit 61 may determine to end the distance measurement in a case where the number of sample points whose position information is updated (changed) is equal to or less than a predetermined value.

In a case where it is determined in step S20 that the distance measurement is not ended yet, the processing returns to step S13, and steps S13 to S20 described above are repeated. Therefore, the distance measuring system 1 receives reflected light from the updated sample points and generates a distance image again.

Meanwhile, in a case where it is determined in step S20 that the distance measurement is ended, the processing proceeds to step S21, and the control unit 51 or the signal processing unit 54 outputs the most recently generated distance image to the upper host device as a final distance measurement result and ends the distance image generation processing. In a case where the generated distance image is output to the upper host device each time in step S15 described above, the processing in step S20 can be omitted.

In the above description of the flowchart of the distance image generation processing in FIG. 10, there has been described an example where the rule ID=3 is applied as the movement rule applied to the sample points and the position information of the sample points is updated.

Meanwhile, for example, in a case where the rule ID=4 is applied as the movement rule applied to the sample points, two distance images are required as described in the second example of the sample point update processing. In this case, the distance measuring device 12 generates two distance images in step S15 described above and then performs the processing in and after step S16.

According to the distance image generation processing described above, the distance measuring device 12 generates a distance image by updating the position information of the sample points on the basis of the sample point state table 71 and the sample point movement rule table 72, thereby generating a distance image at sample positions suitable for the purpose of distance measurement. For example, the sample points can be moved so as to obtain a distance image having a higher spatial resolution for a short distance, or the sample points can be moved so as to obtain a distance image having a higher motion tolerance ability.

In the distance image generation processing described above, the lighting device 11 emits irradiation light by causing the entire VCSEL array to emit light, but positions of VCSELs to emit light may be limited to a part of the VCSEL array according to the positions of the sample points of the light receiving unit 53. This makes it possible to reduce power consumption of the lighting device 11.

### 6. Another Example of Movement Rule

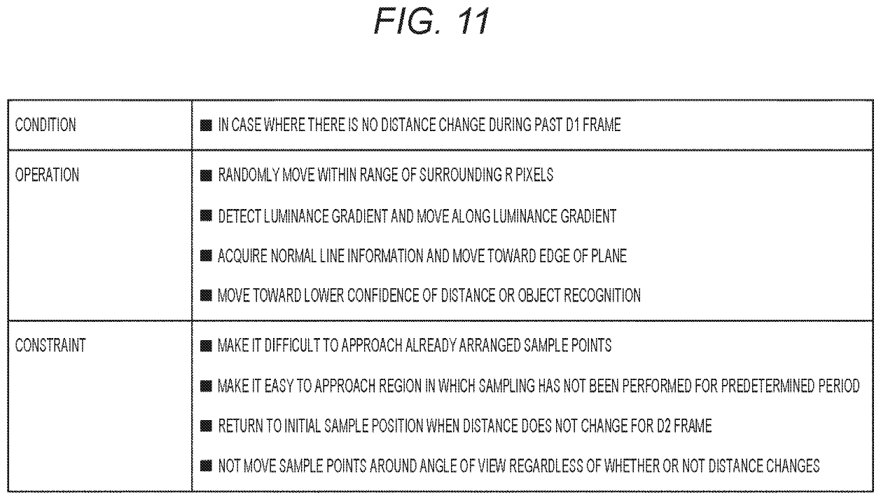

FIG. 11 illustrates another example of the “condition”, the “operation”, and the “constraint” of the sample point movement rule table 72.

For example, in a case where there is no distance change during a past D1 frame (D1>0) as the “condition”, any one of the following “operations” can be applied. Further, any one of the following “constraints” can be set.

As the “operation”,

it is possible to apply any one of
randomly moving the sample point within a range of surrounding R pixels (R>0),
detecting a luminance gradient within a distance measurement range and moving the sample point along the luminance gradient,
acquiring normal line information of the distance measurement range and moving the sample point toward an edge of a plane, and
moving the sample point toward lower confidence of the measured distance or lower confidence of object recognition.

The luminance gradient within the distance measurement range may be obtained by acquiring an image of the external RGB camera or may be obtained from a luminance image obtained by operating the distance measuring device 12 in the luminance observation mode. Alternatively, the luminance gradient may also be obtained from a luminance image based on a count value of a bin in which a peak of a histogram is detected. The normal line information may be acquired from an external device that acquires normal line information perpendicular to a surface (plane) of an object or the like or may be acquired by a predetermined algorithm using a luminance image or a distance image. As the confidence of the distance, the confidence information of the sample point state table 71 can be used. The confidence of the object recognition only needs to be acquired from a result of recognition processing using an image of the RGB camera.

As the “constraint”,

it is possible to set any one of
making it difficult to approach the already arranged sample points,
making it easy to approach a region in which sampling has not been performed for a predetermined period,
returning to an initial sample position when a distance does not change for a D2 frame (D2>0), and
not moving sample points around the angle of view regardless of whether or not a distance changes.

The movement rule is not limited to the above examples and may be other examples. The sample point state table 71 and the sample point movement rule table 72 of the storage unit 63 can be appropriately changed according to the purpose of distance measurement, a characteristic of the object to be captured, an environmental condition of the distance measurement range, and the like.

### 7. Example of Calculating Confidence of Distance

Next, an example of a method of calculating the confidence of the distance recorded in the sample point state table 71 of FIG. 3 will be described.

The confidence of the distance can be a confidence based on an error between a measured distance and a true distance, a confidence based on a certainty (SN ratio) of a signal used for a calculated distance, or the like. Hereinafter, a method of calculating the confidence of the distance based on the SN ratio will be described.

In the sample point, the distance is calculated on the basis of a count value of a bin having the highest height in the histogram by reflected light. All the bins include a noise component caused by ambient light, and thus it is difficult to reliably select a bin used for calculating the distance when the height of the histogram caused by the reflected light is not sufficient. That is, it is considered that a distance measurement result can be more reliable as the SN ratio is higher when the reflected light is a signal and the ambient light is noise.

Therefore, in a certain pixel, how far the count value of the bin (height in the histogram) in which the reflected light is detected is from count values of all the other bins caused by the ambient light is calculated as the confidence.

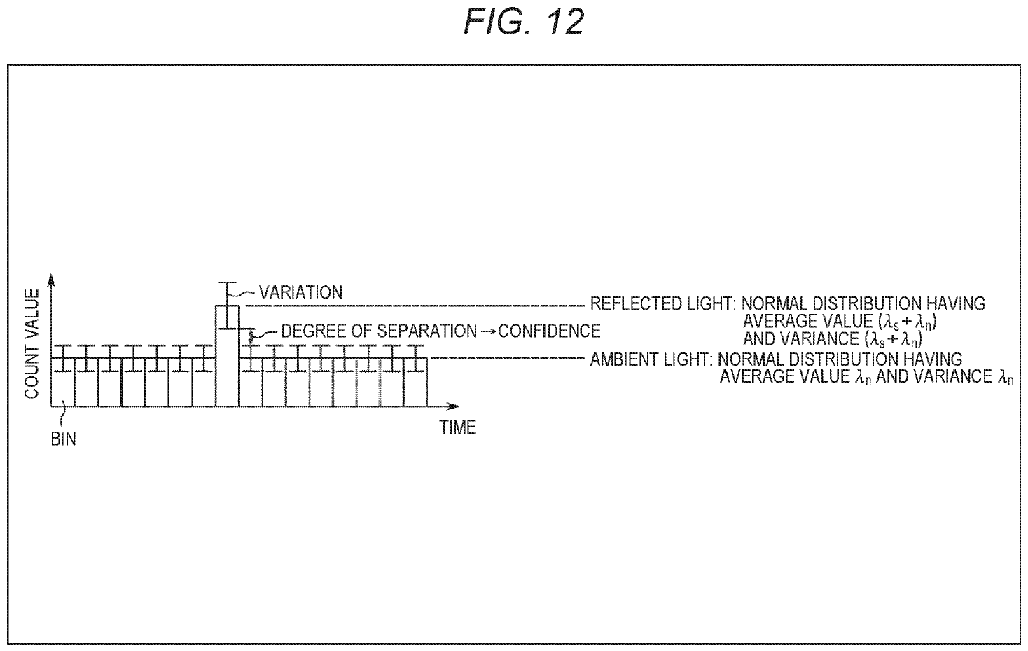

FIG. 12 illustrates a conceptual diagram of a histogram in which the ambient light and the reflected light are captured.

A count value λ of a certain bin follows a Poisson distribution. It is known that, in a case where λ is larger than approximately 10, the Poisson distribution can be approximated to a normal distribution having an average value λ and a variance λ=σ². The count value λ is normally several thousands to several tens of thousands in the distance measuring device 12, and thus the above approximation to the normal distribution can be used.

Specifically, when the ambient light is constant and an average of count values of all bins in which the reflected light is not detected is denoted by λₙ, the count values of the respective bins have a normal distribution in which the average and the variance are λₙ. Further, when an average of count values of bins of only the reflected light is denoted by λₛ, count values of bins in which the reflected light is captured include both the reflected light and the ambient light and thus have a normal distribution in which the average and the variance are (λₛ+λₙ).

In a normal distribution in which the average and the variance obtained by capturing only the ambient light are λₙ, probabilities at which a maximum value of the count value is equal to or less than (λₙ+σₙ), (λₙ+2σₙ), and (λₙ+3σₙ) are 68.27%, 95.45%, and 99.73%, respectively, where a standard deviation is denoted by σₙ32 √(λₙ).

In a normal distribution in which the average and the variance obtained by capturing the reflected light and the ambient light are (λₛ+λₙ), probabilities at which a minimum value of the count value is equal to or more than (λₛ+λₙ−σₛ), (λₛ+λₙ−2σₛ), and (λₛ+λₙ−3σₛ) are 68.27%, 95.45%, and 99.73%, respectively, where a standard deviation is denoted by σₛ=√(λₛ+λₙ).

When a confidence interval is denoted by 1σ, a difference cntdiff between the maximum value of the count value of the ambient light and the minimum value of the count value of (reflected light+ambient light) is given by Expression (1) below.

$$cntdiff = ( {λ}_{s} + {λ}_{n} - {σ}_{s} ) - ( {λ}_{n} + {σ}_{n} ) = {λ}_{s} - {σ}_{s} - {σ}_{n} \qquad ( 1 )$$

A confidence cnf of the distance can be obtained from Expression (2) below by dividing cntdiff in Expression (1) above by a value (σₛ+σₙ) corresponding to the confidence interval 1σ.

$$\begin{matrix}[ Math . 1 ] & \\ cnf = \frac{{λ}_{s} - {σ}_{s} + {σ}_{n}}{{σ}_{s} + {σ}_{n}} = \frac{{λ}_{s} - \sqrt{{λ}_{s} + {λ}_{n}} + \sqrt{{λ}_{n}}}{\sqrt{{λ}_{s} + {λ}_{n}} + \sqrt{{λ}_{n}}} & ( 2 )\end{matrix}$$

When the confidence cnf of Expression (2) is “0”, it can be said that a probability that the count value of the bin is caused not by ambient light noise but by the reflected light is 68.27%. When the confidences cnf are “1” and “2”, the confidences correspond to confidence intervals 2σ and 3σ, respectively, and probabilities that the count value of the bin is caused not by the ambient light noise but by the reflected light are 95.45% and 99.73%, respectively. Hereinafter, similarly, the count value λₛ of the reflected light can be reliably separated from the count value λₙ of the ambient light as the value of the confidence cnf is larger. Thus, the confidence becomes higher.

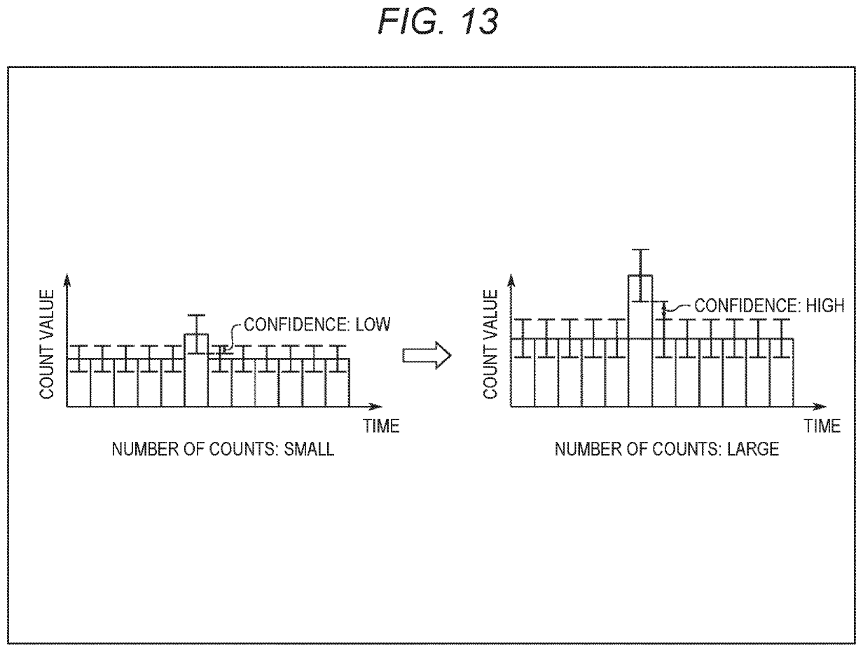

Further, in a case where the confidence cnf of Expression (2) is negative, the count value λₙ of the ambient light is likely to accidentally exceed the count value λₛ of the reflected light due to a variation in the count value λₛ of the reflected light or the count value λₙ of the ambient light as in the histogram on the left side of FIG. 13. Thus, it can be determined that the confidence is low. This occurs in a situation where a sufficient SN ratio cannot be obtained because an influence of the ambient light is large and an emission intensity of the reflected light is weak. In such a case, as in the histogram on the right side of FIG. 13, the SN ratio can be improved by increasing the number of times of emitting the irradiation light to increase the number of counts of the reflected light. This is because an influence of the variation is relatively reduced by increasing the number of counts because a bin having the reflected light has a larger average count value than a bin having only the ambient light. As described above, the distance measuring device 12 can also set the number of times of emission of the irradiation light (the number of counts) so as to obtain a necessary SN ratio according to the emission intensity of the ambient light.

### 8. Another Configuration Example of Distance Measuring System

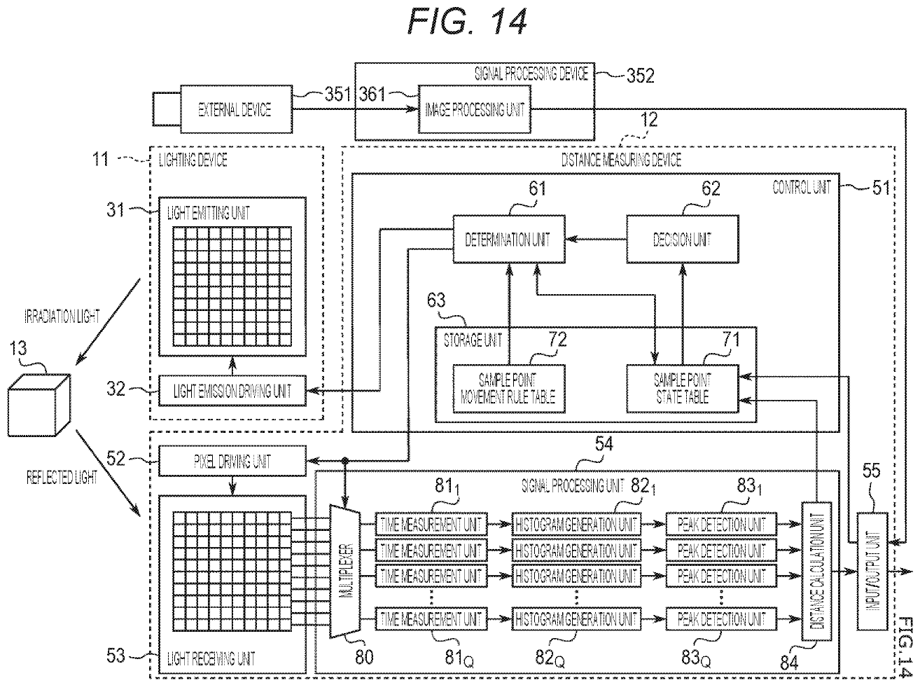

FIG. 14 is a block diagram illustrating a configuration example of another embodiment of the distance measuring system according to the present disclosure.

The distance measuring system 1 of FIG. 14 has a configuration in which an external device 351 and a signal processing device 352 are further added to the first embodiment illustrated in FIG. 1 and the like.

The external device 351 includes, for example, an RGB camera that images a subject including the object 13 and the like. The RGB camera serving as the external device 351 supplies an image signal image obtained by imaging the subject to the signal processing device 352.

The signal processing device 352 includes, for example, a general-purpose personal computer, an FPGA, a DSP, a microprocessor, or the like and processes an image signal supplied from the external device 351. For example, the signal processing device 352 includes an image processing unit 361, and the image processing unit 361 performs predetermined processing such as demosaic processing, YUV conversion processing, normal line detection processing, and object recognition processing on the input image signal. A color image generated by the signal processing device 352 is supplied to the control unit 51 via the input/output unit 55 of the distance measuring device 12.

Note that the signal processing device 352 may be incorporated as a part of the external device 351.

In a case where the RGB camera is provided as the external device 351, for example, a luminance value of the color image supplied from the signal processing device 352 can be used as the luminance information of the sample point state table 71 in FIG. 3. In a case where information such as the normal line information and the confidence of the object recognition is necessary as the “operation” of the movement rule, the image processing unit 361 may calculate the information and supply the information to the distance measuring device 12. The determination unit 61 also uses data detected by the external device 351 to update the position information of the sample points based on the sample point movement rule table 72.

The external device 351 may be a device or a sensor other than the RGB camera. Examples of devices other than the RGB camera include an IR camera that images infrared rays (far infrared ray, near infrared ray), a distance measuring sensor (distance measuring device) by the indirect ToF method, and an event-based vision sensor (EVS). The distance measuring sensor by the indirect ToF method is a distance measuring sensor that detects a time of flight from a timing at which irradiation light is emitted to a timing at which reflected light is received as a phase difference and measures a distance from the object. Further, the EVS is a sensor including a pixel that photoelectrically converts an optical signal and outputs a pixel signal and outputs a temporal luminance change of the optical signal as an event signal (event data) on the basis of the pixel signal. The EVS is an asynchronous camera or address control camera because, unlike a general image sensor, the EVS does not capture images in synchronization with a vertical synchronization signal to output frame data of one frame (screen) at a cycle of the vertical synchronization signal, but outputs event data only at a timing when an event occurs.

For example, in a case where a thermal camera that detects far infrared rays is used as the external device 351, it is possible to detect a temperature in the same range as the distance measurement range and to implement an algorithm (movement rule) that moves sample points according to the temperature.

By providing the external device 351, it is possible to acquire information other than positions of sample points from which the distance measuring device 12 can acquire distance information. Therefore, the distance information can also be interpolated by using the information.

### 9. Configuration Example of Luminance Observation Mode

As described above, the distance measuring device 12 has two modes, i.e., the distance measurement mode and the luminance observation mode as the operation modes. Because a luminance image can be generated in the luminance observation mode, a luminance value of the luminance image generated in the luminance observation mode can be used as the luminance information of the sample point state table 71 in FIG. 3.

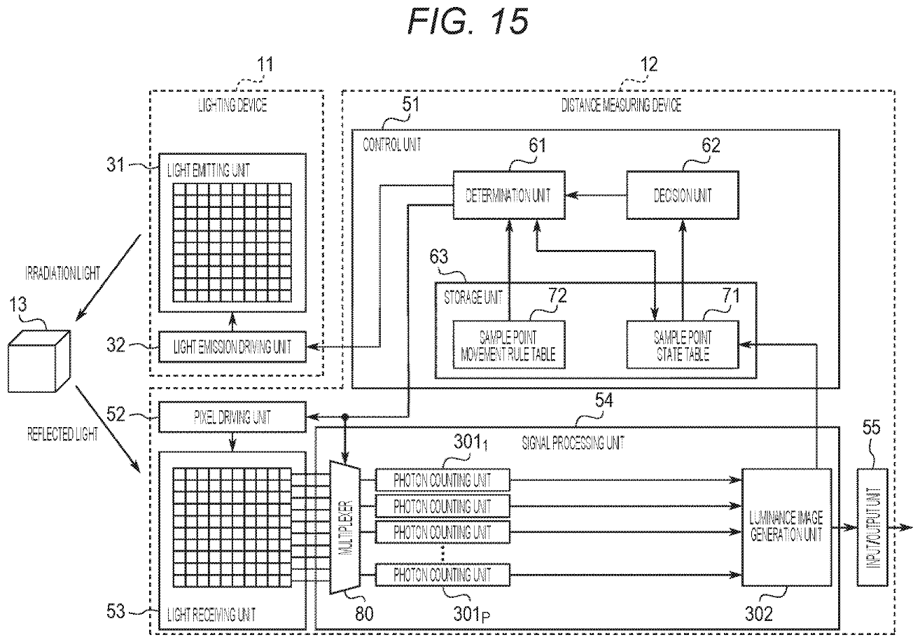

A detailed configuration of the distance measuring device 12 in a case where the operation mode is the luminance observation mode will be described with reference to FIG. 15.

FIG. 15 is a block diagram illustrating a detailed configuration example of the distance measuring device 12 in a case where the operation mode is the luminance observation mode.

In FIG. 15, the same reference signs are given to portions common to the configuration of the distance measuring device 12 in the distance measurement mode in FIG. 2, and description thereof will be appropriately omitted.

In the distance measuring device 12 whose operation mode is the luminance observation mode, the signal processing unit 54 includes photon counting units 301₁ to 301_{P} and a luminance image generation unit 302. Instead, the time measurement units 81₁ to 81_{Q}, the histogram generation units 82₁ to 82_{Q}, the peak detection units 83₁ to 83_{Q}, and the distance calculation unit 84 are omitted. Other configurations of the distance measuring device 12 are similar to those in FIG. 2.

In a case where the operation mode is the luminance observation mode, P (P>0) pixels are set as active pixels in the light receiving unit 53 corresponding to the P photon counting units 301₁ to 301_{P} provided in the signal processing unit 54. The multiplexer 80 connects the active pixels of the light receiving unit 53 to the photon counting units 301 on a one-to-one basis and supplies a pixel signal of each active pixel of the light receiving unit 53 to the corresponding photon counting unit 301.

The photon counting unit 301ⱼ (j=any one of 1 to P) counts the number of times the SPAD of the corresponding active pixel of the light receiving unit 53 has reacted within a predetermined period that is one frame, that is, the number of times a photon has entered. Then, the photon counting unit 301ⱼ supplies the counting result to the luminance image generation unit 302. In a case where the number P of the photon counting units 301₁ to 301_{P} is equal to the total number of pixels of the light receiving unit 53, one luminance image can be generated in one frame. However, in a case where the number P is smaller than the total number of pixels of the light receiving unit 53, one luminance image is generated in a plurality of frames by switching active pixels. The luminance image generation unit 302 generates a luminance image in which the photon counting result measured in each pixel is a pixel value (luminance value) and supplies the luminance image to the control unit 51. As a result, the luminance information in the sample point state table 71 of the storage unit 63 is updated. The generated luminance image may be output to the upper host device via the input/output unit 55.

Note that the photon counting result may be performed not in units of one pixel but in units of multi-pixel (plurality of pixels).

As described above, it is also possible to use the luminance information of the luminance image obtained by setting the operation mode to the luminance observation mode. However, it is necessary to drive the distance measuring device while switching the operation mode between the distance measurement mode and the luminance observation mode, and thus a frame rate to generate a distance image is ½ or less.

### 10. Conclusion

The distance measuring device 12 can arrange sample points of the pixel array so as to obtain more distance information by updating position information of the sample points on the basis of the sample point state table 71 and the sample point movement rule table 72.

More specifically, the determination unit 61 of the distance measuring device 12 updates the position information of the sample points on the basis of the distance information of the sample points described in the sample point state table 71 and the movement rule of the sample points described in the sample point movement rule table 72.

For example, a sample point is moved to a pixel matching with the “operation” of the sample point movement rule table 72 among 3×3 surrounding pixels by referring to the distance information of 5×5 pixels around a current position of the sample point. In a case where the sample point is moved to a position that comes in contact with more sample points whose detected distance is shorter than the own sample point as the “operation”, it is possible to obtain a distance image having a higher spatial resolution for a short distance. Further, in a case where the sample point is moved to a position that comes in contact with more sample points where a change in distance has been detected as the “operation”, it is possible to obtain a distance image having a higher motion tolerance ability.

The sample point movement rule table 72 of the storage unit 63 can be rewritten depending on the purpose of distance measurement. For example, the sample point movement rule table 72 is updated by being transmitted from an external device such as the upper host device. Therefore, the position information of the sample points can be updated by an arbitrary algorithm. The determination unit 61 can store information necessary for the movement rule described in the sample point movement rule table 72 in the sample point state table 71.

Embodiments of the present technology are not limited to the above embodiments, and various modifications can be made without departing from the gist of the present technology.

In the present specification, a system means a set of a plurality of components (devices, modules (parts), or the like), and it does not matter whether or not all the components are in the same housing. Therefore, a plurality of devices housed in separate housings and connected via a network and one device in which a plurality of modules is housed in one housing are both systems.

Note that the effects described in the present specification are merely examples and are not limited, and effects other than those described in the present specification may be provided.

Note that the present technology can have the following configurations.

(1) A distance measuring device including:
a pixel array in which pixels that receive reflected light obtained by reflecting irradiation light from an object are arranged in a matrix;
a determination unit that determines some of the pixels of the pixel array as a sample point for detecting distance information; and
a storage unit that stores a sample point state table that stores distance information of the sample point and a sample point movement rule table that stores a movement rule of the sample point, in which
the determination unit updates position information of the sample point on the basis of the sample point state table and the sample point movement rule table.

(2) The distance measuring device according to (1), in which
the sample point state table stores at least the distance information of the sample point and rule identification information indicating the movement rule applied to the sample point,
the sample point movement rule table stores the movement rule corresponding to the rule identification information, and
the determination unit updates the position information of the sample point by performing the movement rule of the rule identification information described in the sample point movement rule table on the sample point.

(3) The distance measuring device according to (1) or (2), in which
the determination unit applies the movement rule on the basis of the distance information of a first peripheral region around the sample point, determines whether or not to move the sample point to a predetermined position in a second peripheral region smaller than the first peripheral region, and updates the position information of the sample point.

(4) The distance measuring device according to any one of (1) to (3), in which
the determination unit applies one movement rule to the entire pixel array and updates the position information of the sample points.

(5) The distance measuring device according to any one of (1) to (4), in which
the determination unit divides the entire pixel array into a plurality of regions, applies different movement rules to the respective regions, and updates the position information of the sample points.

(6) The distance measuring device according to (5), in which
the plurality of regions includes an outer peripheral region around an angle of view and an internal region inside the outer peripheral region.

(7) The distance measuring device according to any one of (1) to (6), in which
the determination unit updates the position information of the sample point on the basis of the sample point movement rule table and then further updates the position information of the sample point by applying a common entire rule to all the sample points.

(8) The distance measuring device according to (7), in which
the entire rule is a rule in which the sample point is arranged at a position where the distance information has not been measured for a predetermined period.

(9) The distance measuring device according to (7), in which
the entire rule is a rule in which the sample point whose distance information has not been changed for a predetermined period is updated.

(10) The distance measuring device according to any one of (1) to (9), in which
the sample point movement rule table includes, as the movement rule, a rule in which the sample point is moved to a position that comes in contact with more sample points whose detected distance is shorter than the own sample point in a region around the sample point.

(11) The distance measuring device according to any one of (1) to (10), in which
the sample point movement rule table includes, as the movement rule, a rule in which the sample point is moved to a position that comes in contact with more sample points whose short distance change has been detected in a region around the sample point.

(12) The distance measuring device according to any one of (1) to (11), in which
the sample point movement rule table includes, as the movement rule, a rule in which the sample point is moved to a random position in a region around the sample point.

(13) The distance measuring device according to any one of (1) to (12), in which
the movement rule is defined such that a predetermined movement is performed when the sample point satisfies a predetermined condition.

(14) The distance measuring device according to any one of (1) to (13), in which
the movement rule includes an operation that defines a method of moving the position information of the sample point and a condition for performing the operation.

(15) The distance measuring device according to any one of (1) to (14), in which
the movement rule includes an operation that defines a method of moving the position information of the sample point, a condition for performing the operation, and a constraint condition of the operation.

(16) The distance measuring device according to any one of (1) to (15), in which
the sample point state table also stores a confidence of the distance information of the sample point or luminance information of the sample point, and
the determination unit updates the position information of the sample point also by using the confidence of the distance information of the sample point or the luminance information of the sample point.

(17) The distance measuring device according to any one of (1) to (16), in which
the determination unit also acquires data detected by an external device, and
the determination unit updates the position information of the sample point also by using the data detected by the external device.

(18) A method of controlling a distance measuring device, in which
the distance measuring device including a pixel array in which pixels that receive reflected light obtained by reflecting irradiation light from an object are arranged in a matrix
determines some of the pixels of the pixel array as a sample point for detecting distance information,
stores distance information of the sample point in a sample point state table, and
updates position information of the sample point on the basis of the sample point state table and a sample point movement rule table that stores a movement rule of the sample point.

(19) A distance measuring system including:
a lighting device that emits irradiation light; and
a distance measuring device that receives reflected light obtained by reflecting the irradiation light from an object, in which
the distance measuring device includes
   a pixel array in which pixels that receive the reflected light are arranged in a matrix,
   a determination unit that determines some of the pixels of the pixel array as a sample point for detecting distance information, and
   a storage unit that stores a sample point state table that stores distance information of the sample point and a sample point movement rule table that stores a movement rule of the sample point, and
the determination unit updates position information of the sample point on the basis of the sample point state table and the sample point movement rule table.

### REFERENCE SIGNS LIST

1 Distance measuring system
11 Lighting device
12 Distance measuring device
13 Object
31 Light emitting unit
32 Light emission driving unit
51 Control unit
52 Pixel driving unit
53 Light receiving unit
54 Signal processing unit
55 Input/output unit
61 Determination unit
62 Decision unit
63 Storage unit
71 Sample point state table
72 Sample point movement rule table
80 Multiplexer
81 Time measurement unit
82 Histogram generation unit
83 Peak detection unit
84 Distance calculation unit
301 Photon counting unit
302 Luminance image generation unit
351 External device
352 Signal processing device
361 Image processing unit

1. A distance measuring device comprising:
a pixel array in which pixels that receive reflected light obtained by reflecting irradiation light from an object are arranged in a matrix;
a determination unit that determines some of the pixels of the pixel array as a sample point for detecting distance information; and
a storage unit that stores a sample point state table that stores distance information of the sample point and a sample point movement rule table that stores a movement rule of the sample point, wherein
the determination unit updates position information of the sample point on a basis of the sample point state table and the sample point movement rule table.

2. The distance measuring device according to claim 1, wherein
the sample point state table stores at least the distance information of the sample point and rule identification information indicating the movement rule applied to the sample point,
the sample point movement rule table stores the movement rule corresponding to the rule identification information, and
the determination unit updates the position information of the sample point by performing the movement rule of the rule identification information described in the sample point movement rule table on the sample point.

3. The distance measuring device according to claim 1, wherein
the determination unit applies the movement rule on a basis of the distance information of a first peripheral region around the sample point, determines whether or not to move the sample point to a predetermined position in a second peripheral region smaller than the first peripheral region, and updates the position information of the sample point.

4. The distance measuring device according to claim 1, wherein
the determination unit applies one movement rule to the entire pixel array and updates the position information of the sample points.

5. The distance measuring device according to claim 1, wherein
the determination unit divides the entire pixel array into a plurality of regions, applies different movement rules to the respective regions, and updates the position information of the sample points.

6. The distance measuring device according to claim 5, wherein
the plurality of regions includes an outer peripheral region around an angle of view and an internal region inside the outer peripheral region.

7. The distance measuring device according to claim 1, wherein
the determination unit updates the position information of the sample point on a basis of the sample point movement rule table and then further updates the position information of the sample point by applying a common entire rule to all the sample points.

8. The distance measuring device according to claim 7, wherein
the entire rule is a rule in which the sample point is arranged at a position where the distance information has not been measured for a predetermined period.

9. The distance measuring device according to claim 7, wherein
the entire rule is a rule in which the sample point whose distance information has not been changed for a predetermined period is updated.

10. The distance measuring device according to claim 1, wherein
the sample point movement rule table includes, as the movement rule, a rule in which the sample point is moved to a position that comes in contact with more sample points whose detected distance is shorter than the own sample point in a region around the sample point.

11. The distance measuring device according to claim 1, wherein
the sample point movement rule table includes, as the movement rule, a rule in which the sample point is moved to a position that comes in contact with more sample points whose short distance change has been detected in a region around the sample point.

12. The distance measuring device according to claim 1, wherein
the sample point movement rule table includes, as the movement rule, a rule in which the sample point is moved to a random position in a region around the sample point.

13. The distance measuring device according to claim 1, wherein
the movement rule is defined such that a predetermined movement is performed when the sample point satisfies a predetermined condition.

14. The distance measuring device according to claim 1, wherein
the movement rule includes an operation that defines a method of moving the position information of the sample point and a condition for performing the operation.

15. The distance measuring device according to claim 1, wherein
the movement rule includes an operation that defines a method of moving the position information of the sample point, a condition for performing the operation, and a constraint condition of the operation.

16. The distance measuring device according to claim 1, wherein
the sample point state table also stores a confidence of the distance information of the sample point or luminance information of the sample point, and
the determination unit updates the position information of the sample point also by using the confidence of the distance information of the sample point or the luminance information of the sample point.

17. The distance measuring device according to claim 1, wherein
the determination unit also acquires data detected by an external device, and
the determination unit updates the position information of the sample point also by using the data detected by the external device.

18. A method of controlling a distance measuring device, wherein
the distance measuring device including a pixel array in which pixels that receive reflected light obtained by reflecting irradiation light from an object are arranged in a matrix
determines some of the pixels of the pixel array as a sample point for detecting distance information,
stores distance information of the sample point in a sample point state table, and
updates position information of the sample point on a basis of the sample point state table and a sample point movement rule table that stores a movement rule of the sample point.

19. A distance measuring system comprising:
a lighting device that emits irradiation light; and
a distance measuring device that receives reflected light obtained by reflecting the irradiation light from an object, wherein
the distance measuring device includes
a pixel array in which pixels that receive the reflected light are arranged in a matrix,
a determination unit that determines some of the pixels of the pixel array as a sample point for detecting distance information, and
a storage unit that stores a sample point state table that stores distance information of the sample point and a sample point movement rule table that stores a movement rule of the sample point, and
the determination unit updates position information of the sample point on a basis of the sample point state table and the sample point movement rule table.
